(19) United States
(12) Patent Application Publication
(10) Pub. No.: US 2025/0023850 A1
(43) Pub. Date: Jan. 16, 2025

(54) SYSTEMS AND METHODS FOR PROVIDING ACCURATE REQUIREMENTS

(71) Applicant: BrainX, LLC, Broadview Heights, OH (US)

(72) Inventors: Piyush MATHUR, Broadview Heights, OH (US); Francis A. PAPAY, Westlake, OH (US); Kamal MAHESHWARI, Solon, OH (US); Ashish K. KHANNA, Winston-Salem, NC (US); Jacek B. CYWINSKI, Broadview Heights, OH (US); Raghav AWASTHI, Narwal (IN); Shreya MISHRA, Haridwar (IN)

(21) Appl. No.: 18/770,436

(22) Filed: Jul. 11, 2024

Related U.S. Application Data
(60) Provisional application No. 63/513,370, filed on Jul. 13, 2023.

(51) Int. Cl. H04L 9/40; G06F 21/62

(52) U.S. Cl. CPC H04L 63/0457; G06F 21/6218

(57) ABSTRACT

Systems and methods for providing preauthorization requirements are described. An illustrative method may include receiving an input comprising service information and service provider information, retrieving stored preauthorization information from the database based on the service and the service provider, capturing, via a web crawler, raw updated preauthorization information from the networked location, structuring the raw updated preauthorization information using a generative transformer to generate structured updated preauthorization information, detecting changes between the stored preauthorization information and the structured updated preauthorization information, and, in response to detecting changes, updating the stored preauthorization information based on the structured updated preauthorization information.

### CROSS-REFERENCE TO RELATED APPLICATIONS

This application claims priority to U.S. Provisional Patent Application No. 63/513,370filed on Jul. 13, 2023, which is hereby incorporated by reference herein in its entirety.

This application is related to U.S. patent application Ser. No. 18/486,782, titled “AUTOMATED PREAUTHORIZATION USING BLOCKCHAIN,” filed on Oct. 13, 2023,and U.S. patent application Ser. No. 18/486,794, titled “SYSTEMS AND METHODS FOR EXTRACTING INFORMATION FROM SERVICE SUMMARIES,” filed on Oct. 13, 2023,each of which is hereby incorporated by reference herein in their entirety.

### TECHNICAL FIELD

The present disclosure relates generally to systems and methods for providing up-to-date insurance preauthorization requirements. These systems and methods may be used, for example, in claim generation and reimbursement in a hospital information system or other service provider.

### BACKGROUND

Traditional preauthorization processes for insurance are time consuming for both the client and the provider. The processes typically rely on extensive manual review. Preauthorization requirements for a service, as covered by a provider, may be stored in varying systems and formats and use inconsistent language. This variability of insurance-related information makes automation in updating and providing preauthorization difficult. As a result, in typical systems, either the client or an intermediary must search, format, and interpret a vast amount of information, which leads to inflated administrative costs. Furthermore, the information can often be dated or inaccurate due to these time requirements.

A system is needed that automates the management of preauthorization requirements in real-time using machine learning algorithms so that a user can confidently receive up-to-date and accurate information.

### SUMMARY

In some embodiments, a method includes receiving an input including service information and service provider information, matching the service information to a service in a database, matching the service provider information to a service provider in the database, retrieving stored preauthorization information from the database, based on the service and the service provider, accessing a networked location, based on the service and service provider, capturing, via a web crawler, raw updated preauthorization information from the networked location, structuring the raw updated preauthorization information using a generative transformer to generate structured updated preauthorization information, detecting changes between the stored preauthorization information and the structured updated preauthorization information, and, in response to detecting changes, updating the stored preauthorization information based on the structured updated preauthorization information.

In some embodiments, receiving the input includes receiving the input via a selection menu.

In some embodiments, receiving the input includes receiving the input via a text box and parsing the input to determine the service information and the service provider information.

In some embodiments, parsing the input includes using a natural language processor on the input.

In some embodiments, the service provider is associated with a location, and the stored preauthorization information includes at least one of national, regional, and state payer requirements.

In some embodiments, the service includes an insurance coverage of at least one of a medical procedure, a car repair, a home repair, unemployment, or a life.

In some embodiments, the method further includes displaying the stored preauthorization information via a graphical user interface.

In some embodiments, the method further includes, in response to detecting changes, transmitting an electronic message to a user.

In some embodiments, the method further includes confining the generative transformer based on the service.

In some embodiments, the networked location is a predetermined Universal Resource Locator (URL).

### BRIEF DESCRIPTION OF THE DRAWINGS

Aspects and embodiments of this application are depicted in the figures, wherein:

FIG. 1 depicts a flow diagram of an illustrative method for providing accurate preauthorization requirements in accordance with an embodiment.

FIG. 2 depicts an illustrative system for providing accurate preauthorization requirements in accordance with an embodiment.

FIG. 3 depicts an illustrative user interface in accordance with an embodiment.

FIG. 4A depicts illustrative code for capturing and structuring updated preauthorization information in accordance with an embodiment.

FIG. 4B depicts illustrative code for deidentifying user information prior to providing it to a third-party transformer in accordance with an embodiment.

FIG. 5A depicts a user interface for patient management in accordance with an embodiment.

FIG. 5B depicts a user interface for adding a patient in accordance with an embodiment.

FIG. 6 depicts a block diagram of an illustrative data processing system comprising internal hardware that may be used to contain or implement various computer processes and systems.

### DETAILED DESCRIPTION OF EMBODIMENTS

This disclosure is not limited to the particular systems, devices and methods described, as these may vary. The terminology used in the description is for the purpose of describing the particular versions or embodiments only and is not intended to limit the scope of the disclosure.

The following terms shall have, for the purposes of this application, the respective meanings set forth below. Unless otherwise defined, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

As used herein, the singular forms “a,” “an,” and “the” include plural references, unless the context clearly dictates otherwise. Thus, for example, reference to a “cell” is a reference to one or more cells and equivalents thereof known to those skilled in the art, and so forth.

As used herein, the term “about” means plus or minus 10% of the numerical value of the number with which it is being used. Therefore, about 50 mm means in the range of 45 mm to 55 mm.

As used herein, the term “consists of” or “consisting of”' means that the device or method includes only the elements, steps, or ingredients specifically recited in the particular claimed embodiment or claim.

In embodiments or claims where the term “comprising” is used as the transition phrase, such embodiments can also be envisioned with replacement of the term “comprising” with the terms “consisting of” or “consisting essentially of.”

As will be understood by one skilled in the art, for any and all purposes, such as in terms of providing a written description, all ranges disclosed herein are intended as encompassing each intervening value between the upper and lower limit of that range and any other stated or intervening value in that stated range. All ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art, all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 components refers to groups having 1, 2, or 3 components as well as the range of values greater than or equal to 1 component and less than or equal to 3 components. Similarly, a group having 1-5 components refers to groups having 1, 2, 3, 4, or 5 components, as well as the range of values greater than or equal to 1 component and less than or equal to 5 components, and so forth.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

While the present disclosure has been illustrated by the description of exemplary embodiments thereof, and while the embodiments have been described in certain detail, the Applicant does not intend to restrict or in any way limit the scope of the appended claims to such detail. Additional advantages and modifications will readily appear to those skilled in the art. Therefore, the disclosure in its broader aspects is not limited to any of the specific details, representative devices and methods, and/or illustrative examples shown and described. Accordingly, departures may be made from such details without departing from the spirit or scope of the Applicant's general inventive concept.

Many of the examples presented herein reference health insurance. A person of ordinary skill in the art will recognize that these methods may be applied to other types of insurance, including, but not limited to, homeowners, renters, automotive, disability, identity theft, life, life settlement, viatical settlement, umbrella, and business.

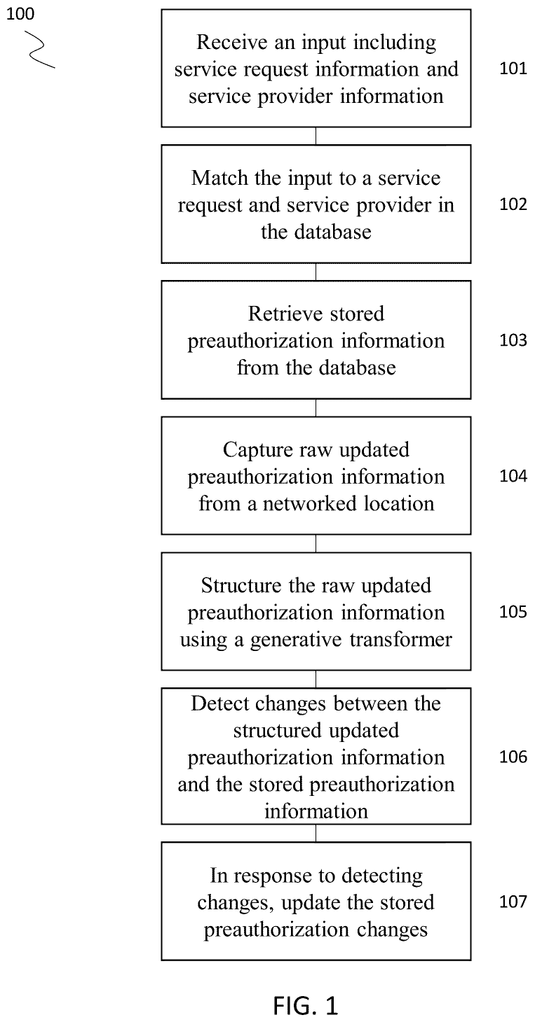

Referring to FIG. 1, an illustrative method 100 for providing accurate preauthorization requirements is depicted in accordance with an embodiment. In certain embodiments, a user submits 101 data including at least one of a service or a service provider. The service provider may directly provide the service (e.g., a hospital) and/or insure the service. In some embodiments, data pertaining to both a providing service provider and an insuring service provider may be submitted 101. In some embodiments, the submitted data may include information pertaining to an episode of service. For example, the episode of service may include a medical diagnosis, a car repair estimate, a home repair estimate, or a life insurance summary.

The user may submit 101 the data through a user interface (UI) in a user portal. In some embodiments, the UI is accessed via a web browser. In other embodiments, the UI is part of an application. In some embodiments, the application is dedicated to answering questions in the field of the service. In some embodiments, the application is a module of a larger application (e.g., a healthcare portal offered by a hospital system). The application may be configured to operate on a personal computer and/or a mobile device. The data may be provided through some combination of free-entry text boxes, dropdown menus, radial button, checkboxes, or any other known entry method. In some embodiments, a text box may be configured to autocomplete and/or suggest relevant entries based on a partial user entry.

The method 100 may further include matching 102 the submitted data to a known service and/or service provider. For example, the service may include an episode of medical care. The service provider may include the care provider and/or the insurance provider. In some embodiments, matching 102 the submitted data to the service and/or service provider can be simplified by providing a user's predetermined options for a service and/or service provider from one or more databases (e.g., via a selection or using autocomplete on a text box). In other embodiments, the matching 102 may be performed on an unstructured text entry. The unstructured text entry may or may not include a single entry combining identifying features of the service and/or the service provider. In such embodiments, the matching 102 may be performed using a machine learning algorithm (e.g., natural language processing). In some embodiments, the matching 102 may include modeling word or phrase associations (e.g., Word2vec) to identify similar services and/or providers. In some embodiments, the matching 102 may be performed with a generative pre-trained transformer (GPT) to structure the input. In some embodiments, the matching 102 may include an intermediary step of identifying a code relevant to the service and/or service provider. For example, a medical service may first be transformed into a best fit Current Procedural Terminology (CPT) code or a Healthcare Common Procedure Coding System (HCPCS) code.

The method 100 may further include retrieving 103 preauthorization information from a database. By locating a matched service and/or service provider, the system may access associated data, from a database, related to the service, the service provider, or the combination thereof. In some embodiments in which the service corresponds to insurance, the database may provide preauthorization information associated with the specific service provider for the service. The preauthorization information may include some combination of preauthorization requirements, client insurance verification information, episodic coverage information, and guidelines. The stored preauthorization information may be provided to the user.

The method 100 may further include capturing 104 raw preauthorization information from the networked location. The networked location may be a trusted third-party location (e.g., a database, website, or blockchain). The trusted third-party can be the matched service provider. In some embodiments, the networked location is a known location at an address (e.g., a Universal Resource Locator (URL) stored in a database. In some embodiments, the networked location is located using a web crawler. The web crawler may be limited to a specific domain associated with the matched service provider or some other trusted third party. Any known method for capturing data from a networked location may be used. Data captured from the networked location may include any combination of structured or unstructured information. In some embodiments, at least some unstructured information may be in a data format requiring optical character recognition (OCR) to convert the raw information into text.

In certain embodiments, some services may have generalized rules across all service providers (e.g., a service required for all insurance policies under the Affordable Care Act). In some embodiments, some services may have generalized rules pertaining to validation of coverage (e.g., a common service).

The method 100 may further include structuring 105 the raw preauthorization information using a transformer. The transformer can be a GPT model. Alternatively, other transformers or natural language processors can be used. In some embodiments, the transformer is customized to a field of use of the service (e.g., medical, auto, life, or home insurance). In some embodiments, the transformer is customized by training the transformer model on a corpus specific to the field. For example, a transformer model for the medical field can be customized to interpret CPT codes. In some embodiments, customization may be performed by providing the transformer with model relevant data structures to be captured. The relevant data structures may be directly provided to the transformer model. Alternatively, the relevant data structures may be provided as a series of questions to ask the transformer (e.g., “Is a hand injury covered by the client's disability insurance policy?” or “Is a bumper replacement covered by the client's car insurance policy?”). In some embodiments, generic questions may be used by the system regardless of the field of use for which the model is used. In other embodiments, certain services, service providers, or combinations thereof may reference customized questions in the database. Captured information can be provided to the transformer along with any structuring information to receive structured preauthorization information. The preauthorization information can include private, national, regional, and state payer requirements.

The method 100 may further include comparing 106 the structured preauthorization information with the stored preauthorization information to detect changes. In some embodiments, structuring the preauthorization information may format the data into simple variables (e.g., strings and numerical values) that can be directly compared. In other embodiments, a transformer model may be used to compare the structured preauthorization information with the stored preauthorization information based on semantic meaning. Based on a detected change, the stored preauthorization information can be updated 107 using the structured preauthorization information. The updated preauthorization information may be provided to the user.

In certain embodiments, the operations relating to capturing, structuring, and updating preauthorization information 104/105/106/107 may be performed on every user request received by the system. In other embodiments, the system may perform these steps on a schedule (e.g., hourly, daily, weekly, etc.). The schedule may be based on the frequency of similar user inputs. For example, if a first user requests requirements relating to a service X and a service provider Y and this was the first such request of the day, the system may perform steps 104/105/106/107 to verify the provided information is up-to-date. If a second user makes the same request relating to a service X and a service provider Y an hour later, the system may exclude those steps 104/105/106/107 and provide the stored information. In another example, the system may perform the updating steps 104/105/106/107 at a low activity time (e.g., 2 AM). The rules (e.g., frequency) for performing the updating steps 104/105/106/107 may vary on a service and/or service provider basis.

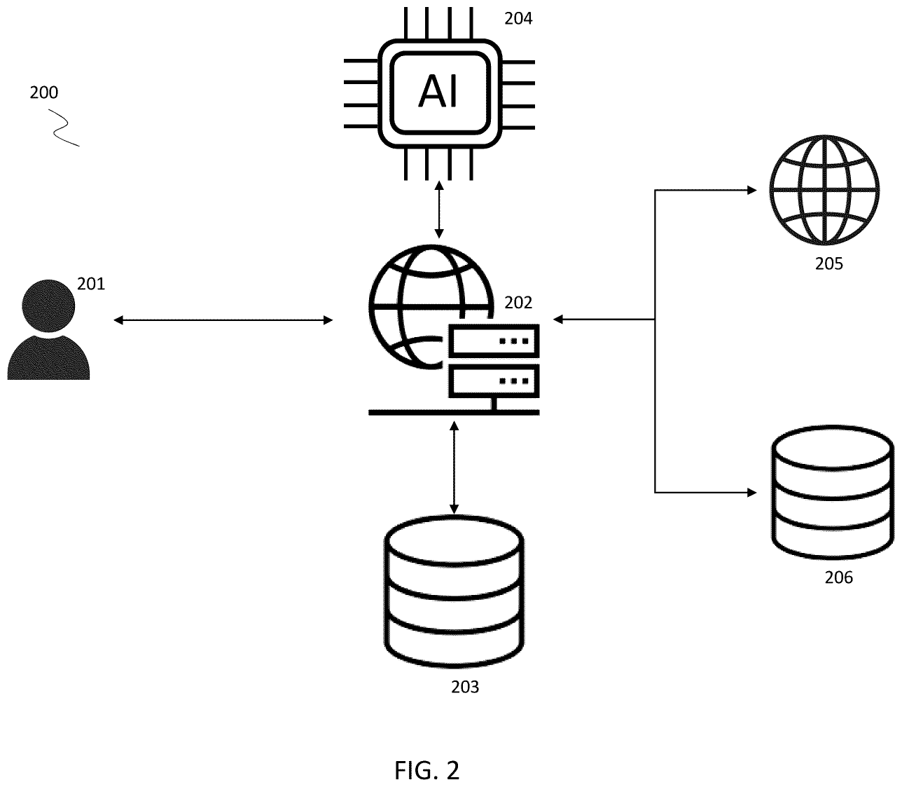

FIG. 2 depicts a block diagram for an illustrative system 200 in accordance with an embodiment. A user 201 may interact with a user portal 202. The user portal 202 may be a website, accessible via a web browser, or a standalone application. The user portal 202 may be configured to be accessible on a variety of computing and/or mobile computing devices.

In some embodiments, the user portal 202 includes an authentication system allowing the user to securely login to the system 200. Authentication may include at least one of a name, a password, a member identification number, a tax identification number, a phone number, or a fax number. One of ordinary skill in the art will recognize that other types of identifying information may also be useful for authentication purposes.

The user portal 202 can include a UI configured to receive input from the user 201. In some embodiments, the user portal 202 can include an audio interface, where a user can dictate input to the system 200. The audio interface may be accessible via a virtual assistant (e.g., Siri, Alexa, Cortana, Google Assistant, etc.).

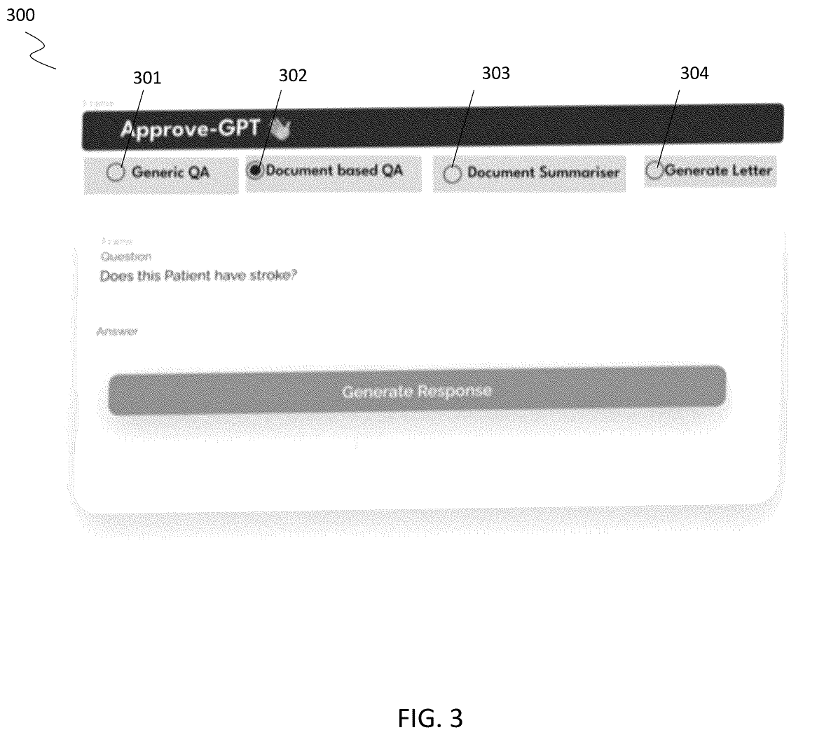

Referring to FIG. 3, an illustrative user interface 300 is depicted in accordance with an embodiment. The UI 300 may include one or more modes 301/302/303/304 of receiving user input. Illustrative modes may include a generic question-answer mode 301, a document-based question-answer mode 302, a document summarizer mode 303, and a document generation mode 304. Although these modes are displayed as selectable options in the example UI 300, a mode of handling the input could be determined based on the semantic meaning of a text input using the transformer model in an alternate embodiment. As a result, multiple modes of operation could be accessible via a single input interface (e.g., a single text box or an audio input).

A generic question-answer mode 301 may allow for generic question inputs. An answer to the submitted generic question may be provided by the transformer model. The answer may be limited to certain classifications of information based on one or more rules put on the transformer model. In some embodiments, the one or more rules to be applied may be determined at least in part based on the user input. In some embodiments, some or all of the one or more rules may be preconfigured. The preauthorization requirements request 101, referenced above, may be one example of a question input in a generic question-answer mode 301.

A document-based question-answer mode 302 may allow for input relating to a specified document. In some embodiments, the document is specified by the user 201. In other embodiments, the document is referenced within the system 200 in association with information provided in the question. The transformer can provide an answer based on information provided in the document.

A document summarizer mode 303 may allow the system 200 to summarize a document. In some embodiments, the document is specified by the user 201. In other embodiments, the document can be referenced within the system 200 in association with information provided in the question (e.g., a stored URL to a website detailing preauthorization requirements for a medical procedure by an insurance company). The transformer can provide a summary of the document.

A document generator 304 can generate documents for the user 201. In some embodiments, document generation includes generating letters. In some embodiments, document generation includes filling out one or more forms. The content generated by the document generator 304 may be some combination of stored form language, stored information (e.g., from a database), and text generated by the transformer.

In some embodiments, the UI 300 may be configured to provide a single answer for each question. In further embodiments, the UI 300 may be configured to prompt the user for additional input when needed.

Referring back to FIG. 2, the user portal 202 may interface to a database 203. The database may include data pertaining to one or more services, service providers, or combinations thereof. In some embodiments, the database may include a reference (e.g., a URL) to an external website 205 or database 206 associated with a service and/or service provider. The external website 205 or database 206 may be affiliated with the service provider or another trusted third-party source. In some embodiments, the system 200 may operate under the assumption that data on the external website 205 or database 206 is valid over data in the local database 203 in case of a discrepancy.

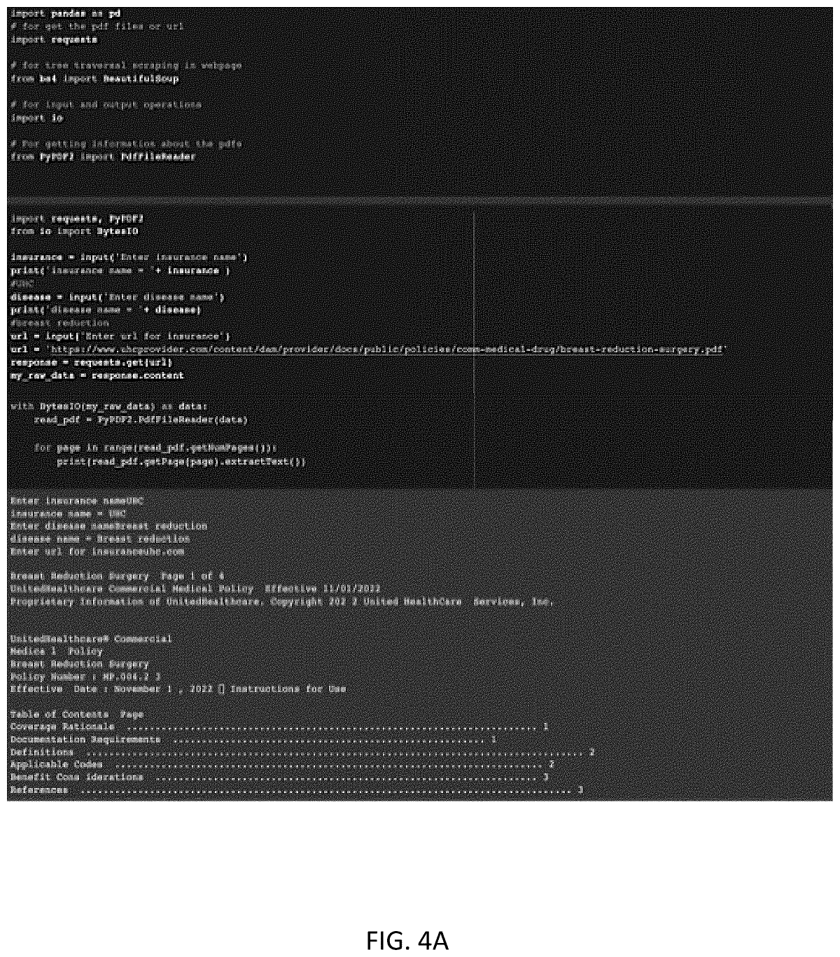

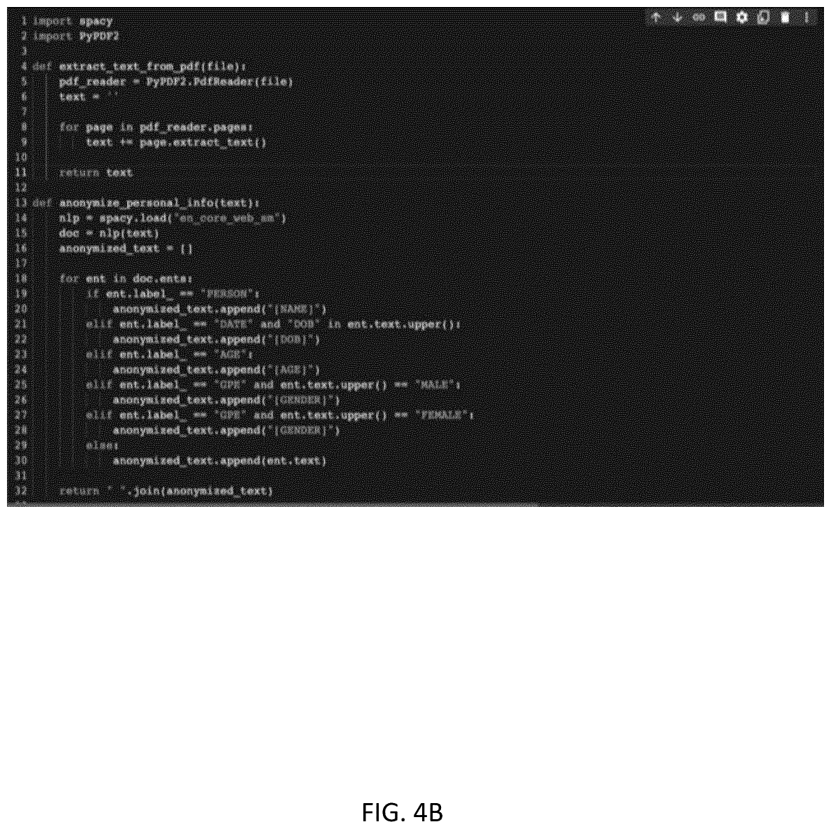

The system 200 may include a web crawler configured to capture data from the external websites 205 and/or databases 206. Referring briefly to FIG. 4A, example code is depicted for capturing preauthorization information from a portable document format (PDF) stored on an external website 205. In further embodiments, the web crawler may also search for and identify potential new locations from which to capture information. In some embodiments, the web crawler may be limited to accessing one or more trusted domains.

In some embodiments, the local database 203, external website, 205 and/or external database includes data relating to a user's insurance policy. The system may validate the user's insurance policy based on this data. In some embodiments, key information for validating insurance may include client eligibility information such as a member or subscriber identifier or plan type. In some embodiments, one or more persons may be associated with the identification information requiring the identification of one of the persons associated with the identification information for whom the authorization request will be made. In certain embodiments, the system 200 validates insurance coverage for the episode of service. Coverage validation may comprise identifying a service and service provider information within the request. In some embodiments, the insurance coverage approval status may be logged.

In some embodiments, the system 200 may include an AI model 204. The AI model 204 can be a transformer as disclosed herein. In some embodiments, the AI model 204 may be run on dedicated hardware to the system 200. In other embodiments, the AI model 204 may be external to the system 200. An external AI model 204 may or may not be publicly facing. An external AI model 204 may be accessed via an API call. In some embodiments, the AI model 204 is configured to not learn from or store any information identified as personal information. In further embodiments, personal information is removed from information prior to providing it to the AI model 204. In some embodiments, the AI model 204 is trained on a generic dataset and/or on a dataset limited to the field of the services described therein.

The systems and methods disclosed herein may be compliant with privacy laws and standards including The Health Insurance Portability and Accountability Act of 1996 (HIPAA). The system may include a deidentifying module configured to remove any personal information from any communications transmitted to external systems (e.g., a GPT model or database). The deidentifying module can include a name entity recognition algorithm. The name entity recognition algorithm can be a machine learning algorithm. In some embodiments, the name entity recognition algorithm is hosted on a first party system. The deidentifying module may further be configured to temporarily store (e.g., cache) the personal information to reintegrate such information with the output of the external system to produce a response to the user. In some embodiments, local storage of personal information may be encrypted. Example code for a deidentifying module is depicted in FIG. 4B.

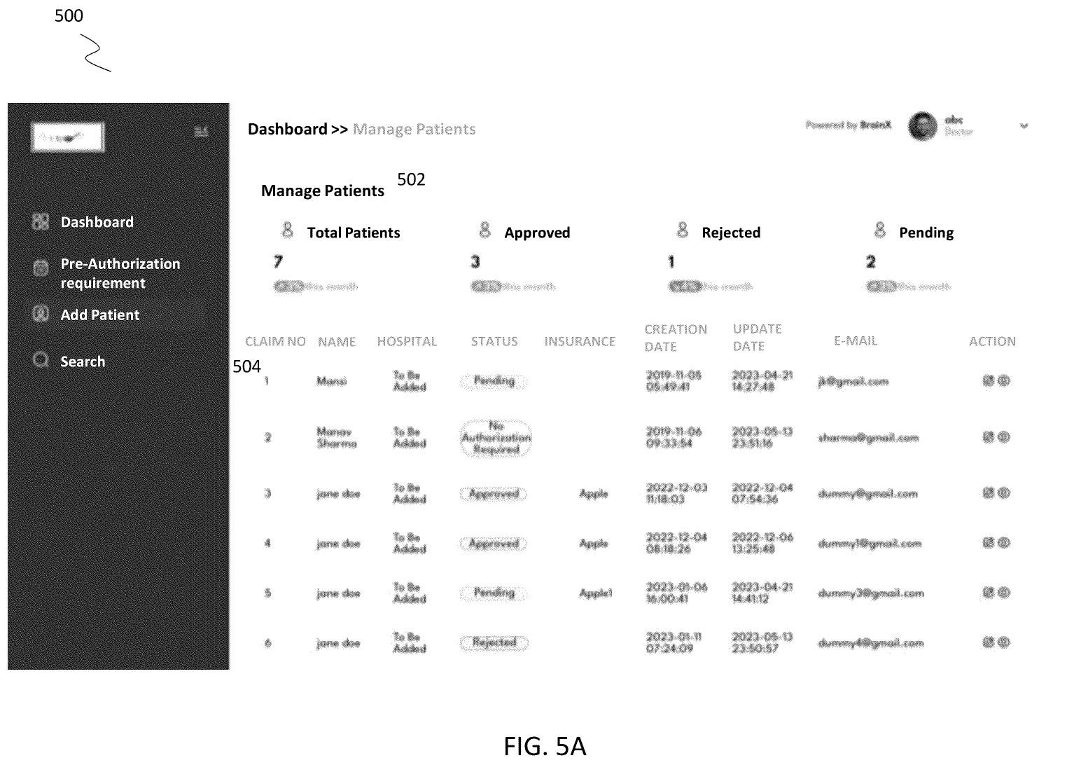

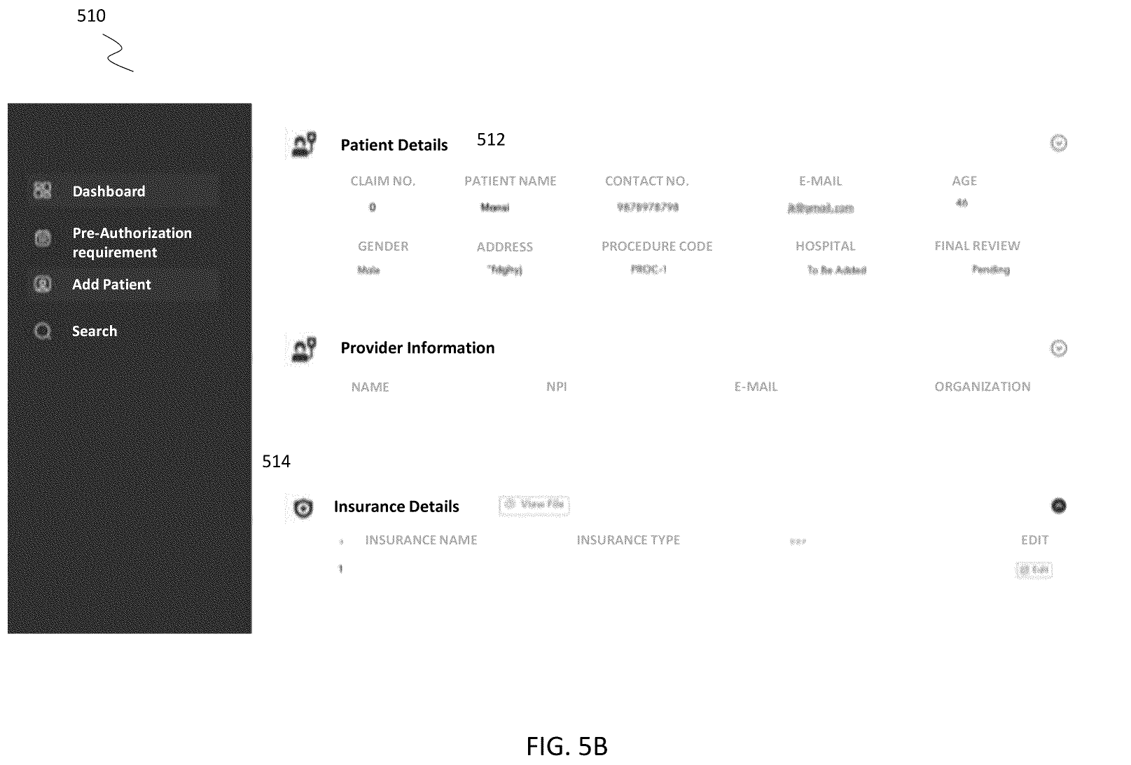

FIG. 5A depicts a user interface 500 for patient management in accordance with an embodiment. The user interface 500 can provide a service or insurance provider information associated with a group of patients 502 or individual patients 504. The information can include personal information, coverage information, and historical information related to provided services. In some embodiments, the information is stored in the local database 203. As a result, some combination of the system 202 and transformer 204 can access the information for generating improved responses. For example, the deidentifying module can use the personal information to identify proper names for removal from third-party communications.

FIG. 5B depicts an example user interface 510 for adding patient information in accordance with an embodiment. As described above, the patient information can include personal information 512 and coverage information 514. Although the embodiments illustrated in FIGS. 5A and 5B referred to patients, the described systems can be adapted to apply to a client of any service.

### Example Computer System

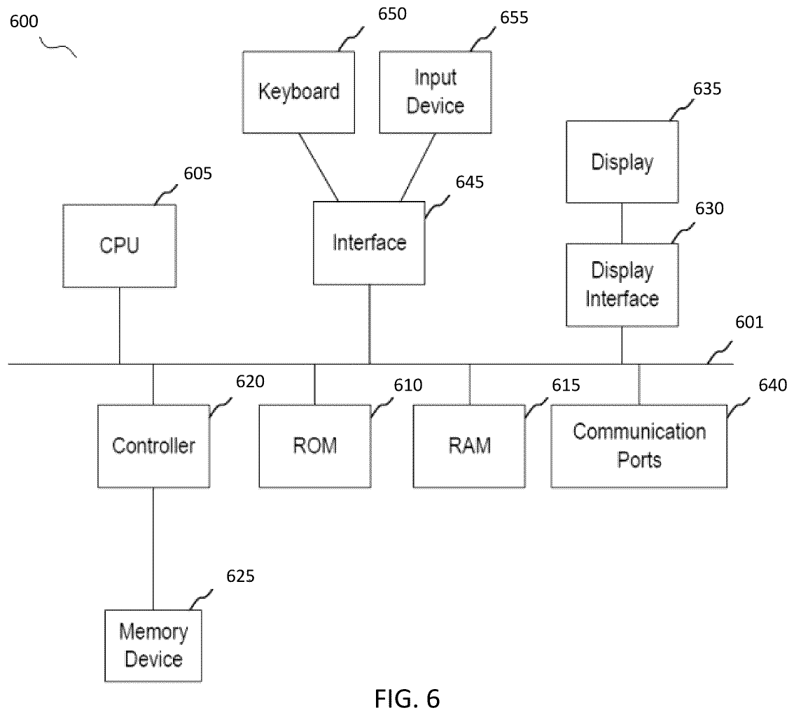

FIG. 6 depicts a block diagram of exemplary data processing system 600 comprising internal hardware that may be used to contain or implement the various computer processes and systems as discussed above. In some embodiments, the exemplary internal hardware may include or may be formed as part of a database control system. In some embodiments, the exemplary internal hardware may include or may be formed as part of an additive manufacturing control system, such as a three-dimensional printing system. A bus 601 serves as the main information highway interconnecting the other illustrated components of the hardware. CPU 605 is the central processing unit of the system, performing calculations and logic operations required to execute a program. CPU 605 is an exemplary processing device, computing device or processor as such terms are used within this disclosure. Read only memory (ROM) 610 and random access memory (RAM) 615 constitute exemplary memory devices.

A controller 620 interfaces with one or more optional memory devices 625 via the system bus 601. These memory devices 625 may include, for example, an external or internal DVD drive, a CD ROM drive, a hard drive, flash memory, a USB drive or the like. As indicated previously, these various drives and controllers are optional devices. Additionally, the memory devices 625 may be configured to include individual files for storing any software modules or instructions, data, common files, or one or more databases for storing data.

Program instructions, software or interactive modules for performing any of the functional steps described above may be stored in the ROM 610 and/or the RAM 615. Optionally, the program instructions may be stored on a tangible computer-readable medium such as a compact disk, a digital disk, flash memory, a memory card, a USB drive, an optical disc storage medium, such as a Blu-ray™M disc, and/or other recording medium.

An optional display interface 630 can permit information from the bus 601 to be displayed on the display 635 in audio, visual, graphic or alphanumeric format. Communication with external devices can occur using various communication ports 640. An exemplary communication port 640 can be attached to a communications network, such as the Internet or a local area network.

The hardware can also include an interface 645 which allows for receipt of data from input devices such as a keyboard 650 or other input device 655 such as a mouse, a joystick, a touch screen, a remote control, a pointing device, a video input device and/or an audio input device.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various features. Instead, this application is intended to cover any variations, uses, or adaptations of the present teachings and use its general principles. Further, this application is intended to cover such departures from the present disclosure as come within known or customary practice in the art to which these teachings pertain. Many modifications and variations can be made to the particular embodiments described without departing from the spirit and scope of the present disclosure as will be apparent to those skilled in the art. Functionally equivalent methods and apparatuses within the scope of the disclosure, in addition to those enumerated herein, will be apparent to those skilled in the art from the foregoing descriptions. It is to be understood that this disclosure is not limited to particular methods, reagents, compounds, compositions or biological systems, which can, of course, vary. It is also to be understood that the terminology used herein is for the purpose of describing particular embodiments only and is not intended to be limiting.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A method for providing requirements, the method comprising:
receiving an input comprising service information and purveyor information;
matching the service information to a service in a database;
matching the purveyor information to a purveyor in the database;
retrieving stored information from the database based on the service and the purveyor;
accessing a networked location based on the service and the purveyor;
capturing raw updated information from the networked location;
structuring the raw updated information using a generative transformer to generate structured updated information;
detecting changes between the stored information and the structured updated information; and
in response to detecting changes, updating the stored information based on the structured updated information.
